(19) United States
(12) Patent Application Publication
(10) Pub. No.: US 2020/0015124 A1
(43) Pub. Date: Jan. 9, 2020

(54) METHOD AND APPARATUS FOR SCALING COVERAGE

(71) Applicant: Avago Technologies International Sales Pte. Limited, Singapore (SG)

(72) Inventors: Samuli TURTINEN, Ii (FI); Sami-Jukka HAKOLA, Kempele (FI); Timo Kalevi KOSKELA, Oulu (FI); Anna PANTELIDOU, Oulu (FI)

(73) Assignee: Avago Technologies International Sales Pte. Limited, Singapore (SG)

(21) Appl. No.: 16/517,691

(22) Filed: Jul. 22, 2019

Related U.S. Application Data
(63) Continuation of application No. 14/278,254, filed on May 15, 2014, now abandoned.

(30) Foreign Application Priority Data
May 16, 2013 (GB) 1308846.3

(51) Int. Cl. H04W 28/18

(52) U.S. Cl. CPC H04W 28/18

(57) ABSTRACT

A method, apparatus and computer program for providing scaled coverage. An example method for use in an access point or station may comprise causing operation in a reduced coverage mode, generating a beacon comprising an indication of a reduced coverage mode in a capability field and one or more coverage scaling parameters (CSP) in an information element, and causing the beacon to be provided to one or more stations (STAs).

### CROSS-REFERENCE TO RELATED APPLICATIONS

This application is a continuation of U.S. application Ser. No. 14/278,254, filed May 15, 2014, which claims priority to UK 1308846.3, filed May 16, 2013, the entire contents of each are incorporated herein by reference.

### TECHNICAL FIELD

Embodiments described in the present disclosure relate generally to a method, apparatus, and computer program product for scaling coverage.

### BACKGROUND

Recent growth in the use of mobile devices, such as for entertainment, for example as sensors and for metering, has led to an increase in the need for access points (APs). Due to a need to accommodate different amounts and types of users at different times, there may be a situation where at least two APs provide coverage to a single area. The overlapping of coverage may lead to unnecessary power use and/or interference.

### BRIEF DESCRIPTION OF THE DRAWINGS

Having thus described embodiments of the disclosure in general terms, reference will now be made to the accompanying drawings, which are not necessarily drawn to scale, and wherein:

FIG. 1 is block diagram of a system that may be specifically configured in accordance with an example embodiment of the present disclosure;

FIG. 2 is a block diagram of an apparatus that may be specifically configured in accordance with an example embodiment of the present disclosure;

FIG. 3 is an example diagram in accordance with an embodiment of the present disclosure;

FIG. 4 is an example flowchart illustrating a method of operating an example apparatus in accordance with an embodiment of the present disclosure;

FIG. 5A is an illustration of a beacon frame body in accordance with an embodiment of the present disclosure;

FIG. 5B is an illustration of an information element in accordance with an example embodiment of the present disclosure

FIG. 5C is an illustration of parameters contained in an information field that may be present in a management/action frame transmitted between STAs (between AP-STAs and between AP and non-AP STAs

FIG. 6 is an example diagram in accordance with an embodiment of the present disclosure;

FIG. 7 is an example diagram in accordance with an embodiment of the present disclosure;

FIG. 8 is an example diagram in accordance with an embodiment of the present disclosure;

FIG. 9 is an example diagram in accordance with an embodiment of the present disclosure; and

FIG. 10 is an example flowchart illustrating a method of operating an apparatus in accordance with an example embodiment of the present disclosure.

### DETAILED DESCRIPTION

A method, apparatus and computer program product are therefore provided according to an example embodiment of the present disclosure for scaling coverage. For example, the method, apparatus and computer program product may be applied to an Overlapping Basic Service Set (OBSS) situation to reduce or eliminate the overlapping coverage by scaling coverage.

In one embodiment of the present disclosure, a method is provided for use in an access point (AP) for basic service set (BSS) coverage scaling, comprising causing operation in a reduced coverage mode, generating a beacon comprising an indication of the reduced coverage mode in a capability field and one or more coverage scaling parameters (CSP) in an information element, and causing the beacon to be provided to one or more stations (STAs).

In another embodiment, a method is provided for use in a station (STA) comprising receiving a beacon comprising an indication of a reduced coverage mode in a capability field and one or more coverage scaling parameters (CSP) in an information element, and causing transmission of uplink (UL) communications in accordance with the CSP.

In one embodiment of the present disclosure, an apparatus is provided comprising a processing system, which may be embodied by at least one processor and at least one memory including computer program code. The processing system is arranged to cause the apparatus to at least cause operation in a reduced coverage mode, generate a beacon comprising an indication of the reduced coverage mode in a capability field and one or more coverage scaling parameters (CSP) in an information element, and cause the beacon to be provided to one or more stations (STAs).

In another embodiment, an apparatus is provided comprising a processing system, which may be embodied by at least one processor and at least one memory including computer program code. The processing system is arranged to cause the apparatus to at least receive a beacon comprising an indication of a reduced coverage mode in a capability field and one or more coverage scaling parameters (CSP) in an information element, and cause transmission of uplink (UL) communications in accordance with the CSP.

In one embodiment, a computer program product is provided comprising a set of instructions, which, when executed by an access point, causes the access point to perform the steps of causing operation in a reduced coverage mode, generating a beacon comprising an indication of the reduced coverage mode in a capability field and one or more coverage scaling parameters (CSP) in an information element, and causing the beacon to be provided to one or more stations (STAs).

In another embodiment of the present disclosure, a computer program product is provided comprising a set of instructions, which, when executed by a station, causes the station to perform the steps of receiving a beacon comprising an indication of a reduced coverage mode in a capability field and one or more coverage scaling parameters (CSP) in an information element, and causing transmission of uplink (UL) communications in accordance with the CSP.

Some example embodiments will now be described more fully hereinafter with reference to the accompanying drawings. Indeed, the example embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present disclosure.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product are provided in accordance with an example embodiment of the present disclosure in order to provide scaled coverage in the event of overlapping BSS or in order to provide power savings.

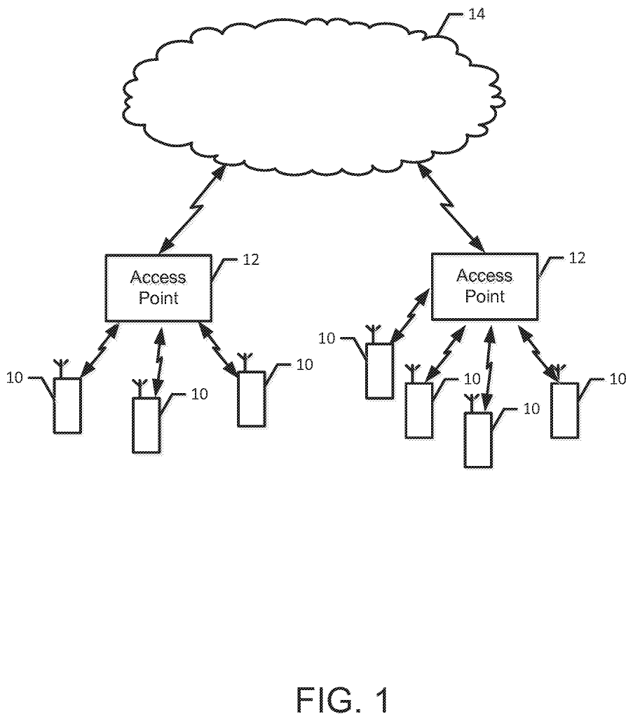

Referring now to FIG. 1, which illustrates an example system that supports communications between a plurality of stations 10 and one or more access points 12 (e.g., a high density system scenario where a plurality of access points may be deployed to a geographical area and may be operating on the same frequency channel), each access point may communicate with one or more stations and, in one embodiment, may communicate with a large number of stations, such as 6.000 or more stations. The access points may, in turn, communicate with a network 14. While the access points may communicate via an Long Term Evolution (LTE) or LTE-Advanced (LTE-A) network, other networks may support communications between the access points including those configured in accordance with wideband code division multiple access (W-CDMA), CDMA2000, global system for mobile communications (GSM), general packet radio service (GPRS), the IEEE 802.11 standard including, for example, the IEEE 802.11ah or 802.11ac standard or other newer amendments of the standard, wireless local access network (WLAN), Worldwide Interoperability for Microwave Access (WiMAX) protocols, universal mobile telecommunications systems (UMTS) terrestrial radio access network (UTRAN) and/or the like.

The access points 12 and the stations 10 may communicate via wireline communications, but most commonly communicate via wireless communications. For example, the access points and the stations may communicate in a sub 1 GHz band as defined by IEEE 802.11 ah standard or in a 5 GHz band, which may be defined by, for example, IEEE 802.11ac standard. The access point may be embodied by any of a variety of network entities, such as an access point, a base station, a Node B, an evolved Node B (eNB), a radio network controller (RNC), a mobile device (e.g., mobile telephones, smart phones, portable digital assistants (PDAs), pagers, laptop computers, tablet computers or any of numerous other hand held or portable communication devices, computation devices, content generation devices, content consumption devices, or combinations thereof), or the like. The stations may also be embodied by a variety of devices, such as sensors, meters or the like. The sensors and meters may be deployed in a variety of different applications including in utility applications to serve as a gas meter, a water meter, a power meter or the like, in environmental and/or agricultural monitoring applications, in industrial process automation applications, in healthcare and fitness applications, in building automation and control applications and/or in temperature sensing applications. Stations that are embodied by sensors or meters may be utilized in some embodiments to backhaul sensor and meter data. Alternatively, the stations may be embodied by mobile terminals or user equipment(s) (UE), such as mobile communication devices, e.g., mobile telephones, smart phones, portable digital assistants (PDAs), pagers, laptop computers, tablet computers or any of numerous other hand held or portable communication devices, computation devices, content generation devices, content consumption devices, or combinations thereof. In an embodiment in which the station comprises a mobile terminal, the communication between an access point and the station may serve to extend the range of wi-fi or another wireless local area network (WLAN), such as by extending the range of a hotspot, and to offload traffic that otherwise would be carried by a cellular or other network.

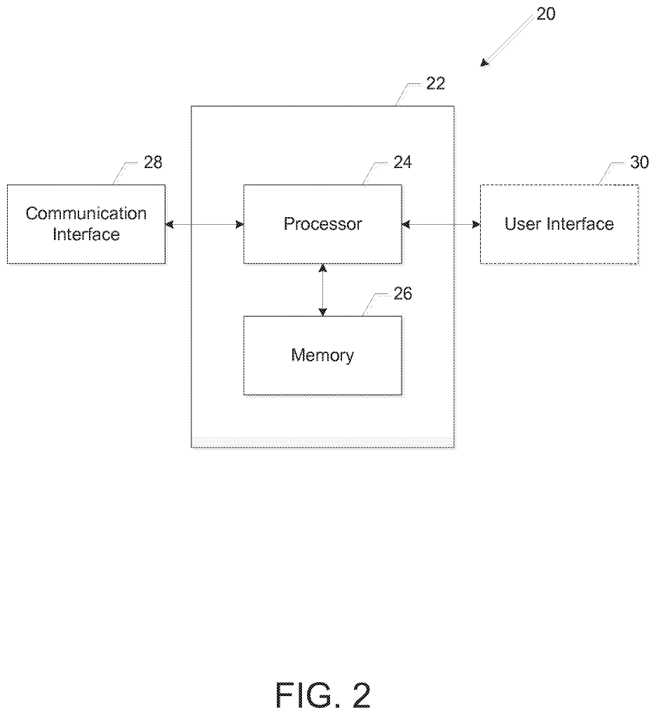

The access point 12 and/or the station 10 may be embodied as or otherwise include an apparatus 20 that is specifically configured to perform the functions of the respective device, as generically represented by the block diagram of FIG. 2. While the apparatus may be employed, for example, by an access point or a station, it should be noted that the components, devices or elements described below may not be mandatory and thus some may be omitted in certain arrangements. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution, signal processing, measurements and report generation, and/or other processing and management services according to an example embodiment of the present disclosure. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present disclosure on a single chip or as a single “system on a chip.” As such, in some cases, a chip or chipset may constitute means for performing one or more operations for providing the functionalities described herein. Alternatively or additionally, a processing system may be embodied by or have similar functionality to the processing circuitry.

In an example embodiment, the processing circuitry 22 may include a processor 24 and memory 26 that may be in communication with or otherwise control a communication interface 28 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments, the processing circuitry may be embodied as a portion of the mobile terminal 10.

The user interface 30 (if implemented) may be in communication with the processing circuitry 22 to receive an indication of a user input at the user interface and/or to provide an audible, visual, mechanical or other output to the user. In this regard, the user interface and/or the processing circuitry 22 may include user interface circuitry configured to facilitate user control of at least some functions based upon user input. The user interface may include, for example, a keyboard, a mouse, a trackball, a display, a touch screen, a microphone, a speaker, and/or other input/output mechanisms. The apparatus 20 need not always include a user interface.

The communication interface 28 may include one or more interface mechanisms for enabling communication with other devices and/or networks, such as for enabling communication between an access point 12 and a station 10 or between two or more stations. In some cases, the communication interface may be any means such as a device or circuitry embodied in either hardware, or a combination of hardware and software that is configured to receive and/or transmit data from/to a network and/or any other device or module in communication with the processing circuitry 22. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present disclosure. For example, the memory may be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an application specific integrated circuit (ASIC), an field programmable gate array (FPGA), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present disclosure while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

A method, apparatus and computer program product are provided in accordance with an example embodiment of the present disclosure in order to provide scaled coverage.

In one example embodiment, the method, apparatus and computer program product may apply to 802.11 in general, with dense deployments of APs in geographical area, and/or in for example, a future 802.11 amendment from (802.11-12/0910r0). In one example embodiment, the method, apparatus and computer program product may provide improved average throughputs through improvement of cell-edge (e.g., BSS-edge) throughput, the reduction of the degrading impact of cell-edge STA on other STA. In another example embodiment, the method, apparatus and computer program product may provide improved scheduling capabilities of the AP to apply fairness strategies, which may for example, also improve the average throughput. The method, apparatus and computer program product of an example embodiment of the present disclosure may also provide improved robustness to interference through better coordination between co-located BSSs for spectrum sharing, interference management and quality of service (QoS), better robustness to band saturation, outdoor deployments, potential range extension, and support for longer delay spreads.

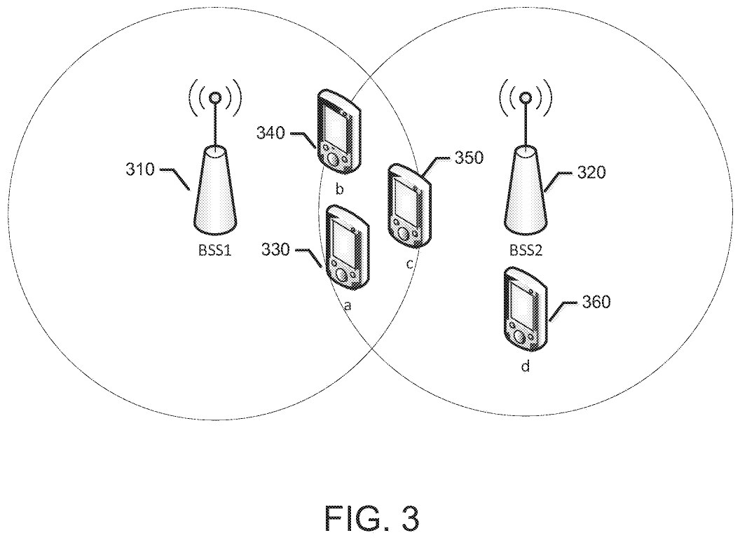

A method, apparatus and computer program product are therefore provided according to an example embodiment of the present disclosure for scaling coverage. For example, the method, apparatus and computer program product may be applied to an OBSS situation is illustrated in the FIG. 3 for which one or more embodiments of the present disclosure may be applied. In FIG. 3, AP 310 and AP 320 provide coverage to stations STA “a” 330, STA b 340, STA c 350, and STA d 360. Though STAs 330 and 340 may be associated with a first basic service set (BSS) (e.g., BSS1) and STAs 350 and 360 may be associated with a second BSS, e.g., BSS2, STAs 330, 340, and 350 are in the coverage area of both BSS1 and BSS2. A method, apparatus and computer program product are provided for scaling coverage to reduce or eliminate the overlapping coverage by scaling coverage.

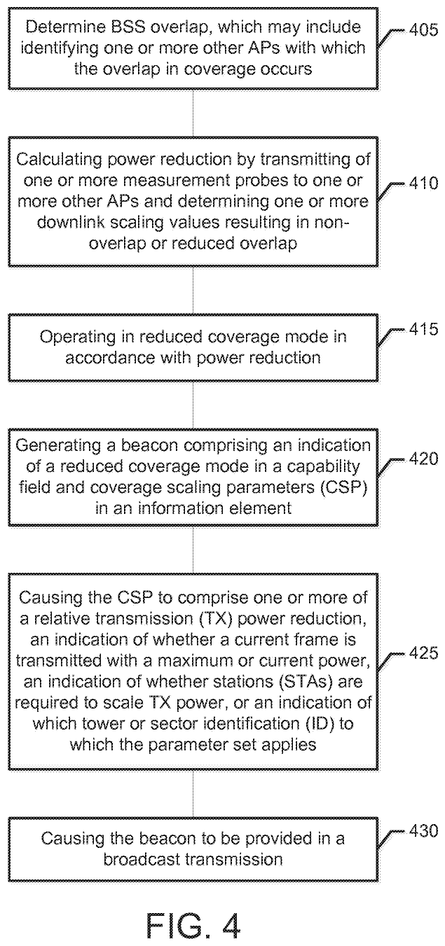

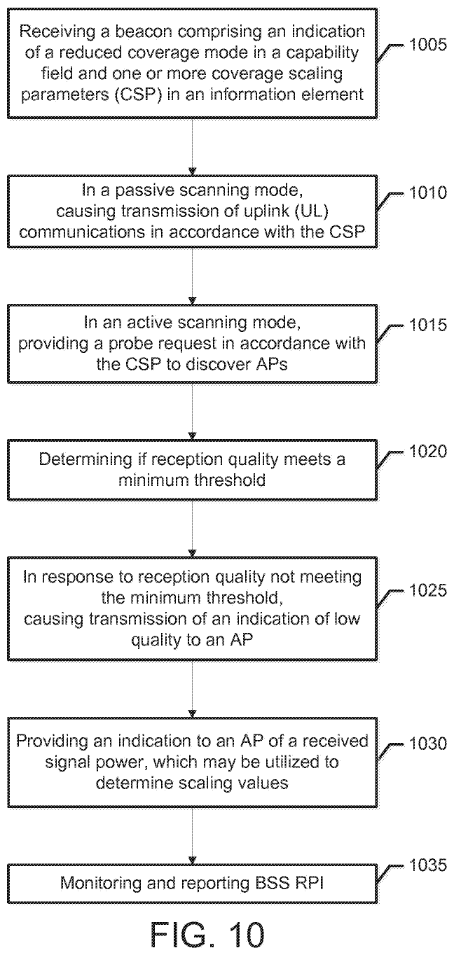

FIGS. 4 and 10 illustrate an example flowchart of the example operations performed by a method, apparatus and computer program product in accordance with an embodiment of the present disclosure. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present disclosure and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 4 and 10 when executed, convert a computer or processing circuitry into a particular machine configured to perform an example embodiment of the present disclosure. Accordingly, the operations of FIGS. 4 and 10 define an algorithm for configuring a computer or processing to perform an example embodiment. In some cases, a general purpose computer may be provided with an instance of the processor which performs the algorithms of FIGS. 4 and 10 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included. It should be appreciated that each of the modifications, optional additions or amplifications below may be included with the operations above either alone or in combination with any others among the features described herein.

Referring now to FIG. 4, operations are shown for a method of operation for use in an AP. The operations may be performed by an apparatus 20, such as illustrated in FIG. 2, embodied by a computing device 10, and will be hereinafter described. FIG. 4 is an example flowchart illustrating a method for use in an AP for coverage scaling.

Referring now to block 405 of FIG. 4, the apparatus may include means, such as the processing circuitry 22, the processor 24 or the like, for determining a BSS overlap. In one embodiment, determining a BSS overlap may include identifying one or more APs with which the overlap in coverage is occurring. In another embodiment of the present disclosure, the apparatus may be configured to determine that there is an overlapping BSS in its area if it hears its Beacons or other broadcast messages or if it overhears messages originating or destined to that BSS. In one exemplary embodiment, an apparatus may determine that through the “to DS” and “from DS” fields of the Frame Control field of the MAC header in 802.11 networks.

Referring now to block 410 of FIG. 4, the apparatus may include means, such as the processing circuitry 22, the processor 24 or the like, for calculating a power reduction. In one embodiment, the apparatus may be configured to transmit results from one or more measurement probes to one or more APs. Based on results of the measurement probes, the apparatus may be configured to determine one or more downlink (DL) scaling values for reducing or eliminating overlap of coverage. In another embodiment, the apparatus may be configured to transmit results from one or more measurement probes or requests to one or more stations. The apparatus may request a power value of a received request to be transmitted back. Upon receiving the reply from one or more stations, the apparatus may be configured to calculate a power reduction.

Referring now to block 415 of FIG. 4, the apparatus may include means, such as the processing circuitry 22, the processor 24 or the like, for operating in a reduced coverage mode in accordance with the calculated power reduction.

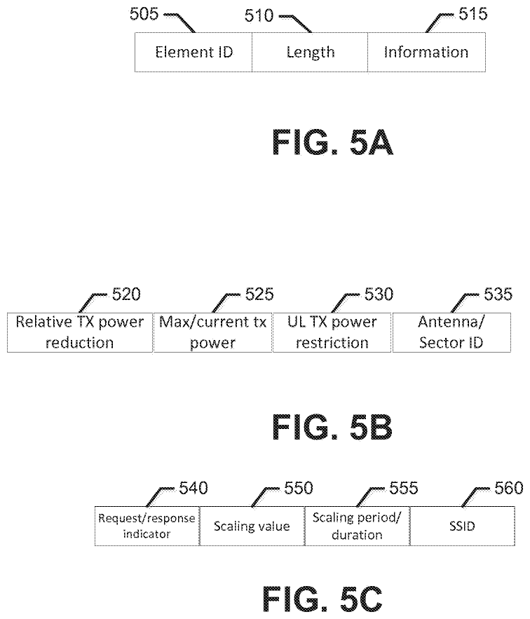

Referring now to block 420 of FIG. 4, the apparatus may include means, such as the processing circuitry 22, the processor 24, the communication interface 28 or the like, for indicating a reduced coverage mode by sending a scaling indication, in for example a broadcast transmission. In one embodiment, the apparatus is configured for generating a beacon indicating scaling comprising an indication of a reduced coverage mode in, for example, a capability field and one or more coverage scaling parameters (CSP) in an information element. In one embodiment of the present disclosure, the capability field may be part of one or more management messages sent by STAs. For example, a scaling capability field may exist in one or more of a Probe Request, Association Request and Reassociation Request frames. Based on this capability, the apparatus may be configured to accept or reject association to the BSS. For example, if a STA does not have the scaling capability, an AP that forces all its STAs to scale their transmission power may determine to not respond to a Probe Request or to the (Re)Association request sent by the STA. FIG. 5A shows an example of broadcast transmission comprising an element ID 505, a length 510, and an information element 515.

Referring now to block 425 of FIG. 4, the apparatus may include means, such as the processing circuitry 22, the processor 24, the communication interface 28 or the like, for causing the CSP to comprise one or more of a relative transmission power reduction, an indication of whether a current frame is transmitted with a maximum or current power, an indication of whether STAs are required to scale transmission power, and an indication of which tower or sector identifier to which the parameter set applies. In one embodiment of the present disclosure, multiple information elements may be sent by an AP, for example, to describe one or more different scalings and/or transmission power parameters used for different sectors or towers. FIG. 5B shows for example, an information element comprising a relative transmission (TX) power reduction 520, a maximum or current TX power indication 425, a UL TX power restriction 530 and an antenna/sector ID 535. FIG. 5C shows an example of information that may be present in a management/action frame that is transmitted between non-AP STAs and AP or between APs (e.g. in case the scaling of TX powers is coordinated). The information may include e.g. an indication of whether the frame is a request/response 540, a scaling value that is requested 550, the duration (how long the value is valid) of the requested/responded value or the periodicity of the scaling 555 e.g. expressed in beacon intervals or other time units commonly used in 802.11. The information may also include the address of the requester or responder 560.

In one example embodiment, the apparatus may be configured to indicate and/or negotiate a duration value for the scaling to, for example, an adjacent AP. In another embodiment, APs may coordinate the BSS coverage scaling in such a manner that an AP (and STAs) utilize scaled TX power in the BSS for and/or during a specific period of time (e.g. t0 to t1) and adjacent AP utilizes scaling for the time period t1-t2. The coordination of coverage areas between AP allows API to serve BSS edge users (with high TX power) while adjacent AP utilizes lower power to serve STAs that are close to it without causing unnecessary interference to each other. In one embodiment APs may send specific requests (e.g. a management frame) BSS scaling request/response to each to request coverage area scaling. Alternatively such messages may be included or such information may be included to control frames such as Acknowledgement (ACK), negative acknowledgement, (NACK), Ready to send (RTS), or clear to send (CTS) or the like. In a further related embodiment, APs may indicate to STAs one or more scaling periods and thus STAs have knowledge when to utilize (i.e. when they are allowed to) maximum TX power and when the TX power has to be limited. In one embodiment, one or more adjacent APs may accept or reject the request. When, for example, an adjacent AP accepts the request, the apparatus may be configured to indicate the TX power scaling in the beacon and include a duration. In one embodiment, the message may be unicast to one or more STAs or sent to a group address identifying the one or more STAs. The STAs that remain in coverage after the scaling may transmit/receive from this second AP as before. In one embodiment, after the duration of scaling expires, the second AP may increase its scaling back to its previous value.

In one embodiment, the AP may transmit one or more beacons (or other management and control frames) with non-scaled transmission power, such as for example, maximum allowed power. The apparatus may be configured to include one or more fields in the IE. Relative transmission (TX) power Reduction may indicate the TX power reduction in decibels (dBs), MAX/Current power may indicate whether the current frame is transmitted with maximum power and/or include the current power in dBs, UL TX power restriction may indicate whether STAs are required to scale the TX power when transmitting a frame in this BSS (which may or may not include the pre-association frames), and Antenna/Sector ID may indicate the antenna or sector ID which the parameter set applies. In one embodiment, multiple parameter sets may be transmitted.

Referring now to block 430 of FIG. 4, the apparatus may include means, such as the processing circuitry 22, the processor 24, the communication interface 28 or the like, for causing the beacon to be provided. In one embodiment, the apparatus may be configured to transmit the beacon in a broadcast transmission. In another embodiment, the apparatus may be configured to transmit the beacon in a unicast transmission.

In one embodiment, an AP may request BSS coverage scaling from one or more other APs, for example, adjacent APs. In reduced coverage mode, an AP may transmit measurement probes to adjacent APs to determine and negotiate downlink scaling values. AP may also request STA to send probes/training signals that will be received by both APs (and these probe transmission periods may be coordinated between APs) to find out the optimum scaling value for the BSSs. These probes may be also sent by an AP. The apparatus, such as the processing circuitry 22, the processor 24 or the like, may be configured to determine the maximum reduction value that may be used. The maximum reduction value may depend on current STAs that are associated. In one embodiment, the apparatus may indicate its power headroom (e.g., how much it can increase its current TX power), UL TX power limitation active which may indicate whether the UL TX power is limited, a current transmission power, etc.

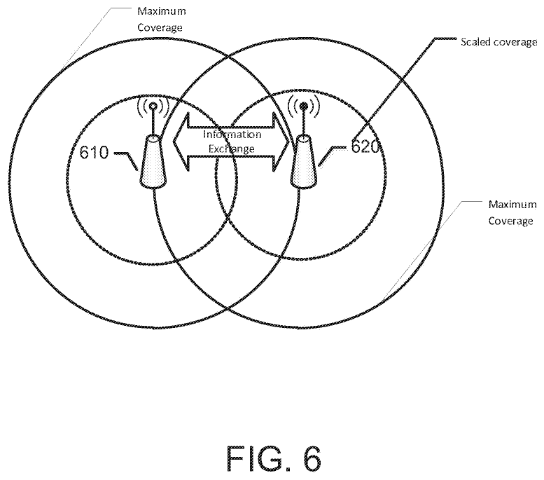

FIG. 6 shows an embodiment where the apparatus may be configured to share communications with an adjacent AP. In one embodiment, the apparatus embodied or otherwise associated with AP 610 may request adjacent APs, such as for example AP 620, to measure one or more specific transmissions, each with for example, different scaling parameters, and report results back. In one embodiment, measurements may also be bi-directional. For example, a sequence of request-response frames may be used to reduce the overlapping coverage areas. In one embodiment, once the coverage scaling is made, APs may exchange information (such as for example, management information, with higher coverage transmission power, for example, maximum or previous transmission power).

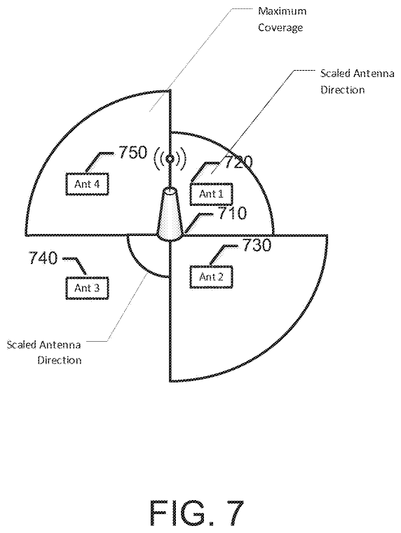

FIG. 7 shows an example embodiment of an AP configured with directional antennas or adaptive antennas. In one embodiment, the apparatus, such as the processing circuitry 22, the processor 24 or the like, may scale the coverage per direction. For example, AP 710 may be configured with four antennas, Ant1 720, Ant2 730, Ant3 740, and Ant4 750. Each antenna may be configured to provide coverage at least one predetermined direction, for example, 90 degrees apart from each other in AP 710. In one embodiment, an apparatus embodied or otherwise associated with an AP 710 may provide one or more levels of coverage scaling according to the method shown in FIG. 4. As shown in FIG. 7, AP 710 may be configured to provide more than one (e.g., 4) different level of coverage scaling. In some embodiments, each direction may be additionally signaled by having multiple parameter sets in the CSP IE.

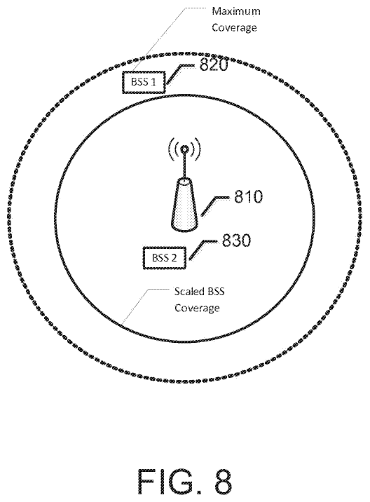

FIG. 8 shows an example embodiment where a single AP supports multiple BSS. An apparatus embodied or otherwise associated with AP 810 may be configured for scaling on a BSS basis. For example, an apparatus embodied or otherwise associated with AP 810 may be configured to provide scaled coverage for a first BSS, e.g., BSS1 820, while providing no scaled coverage or a different scaled coverage for a second BSS, e.g., BSS2 830. In one embodiment, AP 810 may be configured with a BSS per antenna direction.

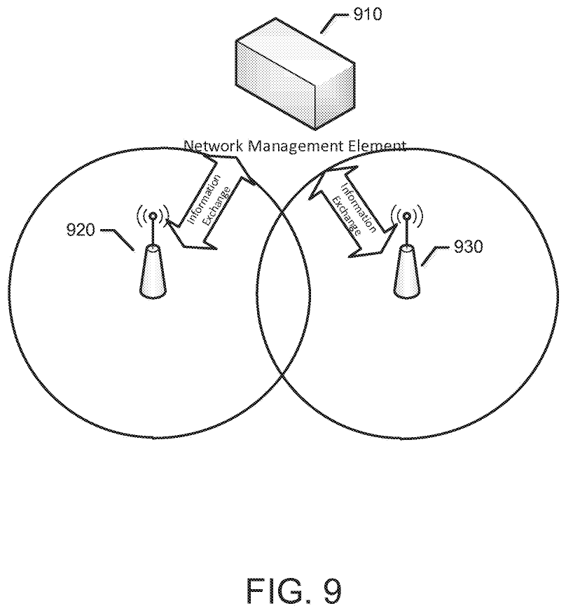

FIG. 9 shows an example embodiment where coverage scaling may be requested by a different apparatus, for example, a higher level network management entity. One or more APs, which may belong to the ESS may be requested by network management entity to negotiate the parameters for scaled coverage. Here, network entity 910 may be configured to communicate with AP 920 and AP 930. As such, AP 920 and AP 930 may be configured to communicate with network entity 910. One or more methods or embodiments for coverage scaling may be utilized by network entity 910 or a combination of network entity 910 and one or more of AP 920 and 9230. In one embodiment, an AP may not be able to connect directly to a second AP. In such as case, scaling may be negotiated via network entity 910.

Referring now to FIG. 10, operations are shown for a method of operation for use in a STA. The operations may be performed by an apparatus 20, such as illustrated in FIG. 2, embodied by a computing device 10, and will be hereinafter described. FIG. 10 is an example flowchart illustrating a method for use in an STA for coverage scaling.

Referring now to block 1005 of FIG. 10, the apparatus may include means, such as the processing circuitry 22, the processor 24, the communication interface 28 or the like, for receiving a transmission comprising an indication of a reduced coverage mode and one or more scaling parameters. In one embodiment, the apparatus may be configured for receiving a beacon comprising the indication of reduced coverage in a capability field and one or more scaling parameters in an information element.

Referring now to block 1010 of FIG. 10, the apparatus may include means, such as the processing circuitry 22, the processor 24, the communication interface 28 or the like, for, in accordance with a passive scanning mode, causing transmission of an uplink (UL) communication in accordance with the CSP.

Referring now to block 1015 of FIG. 10, the apparatus may include means, such as the processing circuitry 22, the processor 24, the communication interface 28 or the like, for in accordance with an active scanning mode, providing a probe request in accordance with the CSP to discover APs. Referring now to block 1020 of FIG. 10, the apparatus may include means, such as the processing circuitry 22, the processor 24, the communication interface 28 or the like, for determining if reception quality meets a minimum threshold.

Referring now to block 1025 of FIG. 10, the apparatus may include means, such as the processing circuitry 22, the processor 24, the communication interface 28 or the like, for in response to determining that reception quality does not meet a minimum threshold, causing transmission of an indication of low quality to an AP. Referring now to block 1030 of FIG. 10, the apparatus may include means, such as the processing circuitry 22, the processor 24, the communication interface 28 or the like, for providing an indication to an AP of a received signal power. In one embodiment, the indication may be utilized to determine scaling values by an AP. Referring to block 1035 of FIG. 10, the apparatus may include means, such as the processing circuitry 22, the processor 24, the communication interface 28 or the like, for monitoring and/or reporting BSS RPI.

In one embodiment, for example, in a passive scanning mode, the STA may read the CSP IE in the beacon and determine transmission power for the initial access by reading the “relative power reduction” field and scale TX power according to the relative scaling value. In one embodiment, if the received power level—‘relative tx power reduction value’ is below a minimum receiver sensitivity value (e.g. −82 dbm 1/2 BPSK)+an offset, the STA may use maximum power. In another embodiment, a STA may also use maximum allowed power if an UL TX power reduction bit is not set. Alternatively, an AP may set UL TX power limit to indicate whether a STA may use reduced transmission power while communicating with AP.

In another embodiment, for example, in an active scanning mode, a STA may send a probe request with maximum allowed TX power to discover APs. APs may respond with power scaling parameters described in the FIG. 4. In one embodiment, if UL TX power reduction is set, further frame exchange with AP may occur with scaled TX power, such as for example, association and/or authentication.

In one embodiment, if a STA is scanning for known SSID, the STA may use power ramp up. For example, the probe request transmission power may be scaled. The last recorded scaling value may be used for the first transmission of the probe request and the value may then be increased by N-dB for the subsequent transmission. When scanning with power ramp-up, the STA may limit the number of scanning messages, for example limiting scanning messages to 3, and in turn increase the minimum probe delay.

In one embodiment, an AP may request a STA to indicate the received signal power its (beacon) in the association request. For example, the request may be provided in the beacon or a probe response. In one embodiment, an AP may determine one or more scaling values based on indicated received power levels in the association response from the STA. An AP may indicate in the association response or, alternatively, in a post-association management frame, a coverage RPI measurement request which may trigger a STA to indicate if the measured RPI falls below an indicated threshold and an indication that the AP is operating in the reduced coverage mode. In one embodiment, an AP may utilize an indication that the RPI has fallen below a threshold to increase the coverage and/or suggest another AP (e.g., in extended service set (ESS))

In one embodiment, a STA may assist coverage scaling. For example, an AP may request and/or a STA may be requested to monitor BSS RPI and report it to the AP that the STA is connected to. An AP may request an OBSS report. The OBSS report may require an STA to monitor other BSS transmissions. In one embodiment, the OBSS report may include the received signal strength of the OBSS. In some embodiments, an AP may use the reports to determine potential coverage reduction. In one embodiment, if an STA cannot detect any physical layer convergence protocol (PLCP) header but does receive the clear channel assessment (CCA)-busy indication from the CCA Energy detector, it may report unknown BSS. A STA may optionally transmit RPT measurement report for adjacent BSS by using, for example, public action frames, to report the signal strength of an AP to which it is not connected.

In one embodiment, a STA may detect low reception quality with the current scaled transmission power and autonomously provide an indication to an AP to increase power. In another embodiment, an AP may provide information from including, for example, a flag indicating whether a STA is allowed to send the indication.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus, comprising:
processing circuitry configured to:
receive a beacon from an access point (AP), the beacon including a capability field and an information element, the capability field including an indication that the AP is operating in a reduced coverage mode, and the information element including a plurality of coverage sealing parameters (CSPs);
transmit, in response to the apparatus operating in a passive scanning mode, uplink (UL) communication in accordance with the CSPs; and
transmit, in response to the apparatus operating in an active scanning mode, a probe request in accordance with the CSPs, wherein
the reduced coverage mode of the AP reducing an overlap between a first coverage area of the AP and a second coverage area of another AP.

2. The apparatus according to claim 1, wherein the plurality of CSPs include:
a relative transmission (TX) power reduction,
an indication of whether a current frame is transmitted with a maximum or current power,
an indication of whether stations (STAs) are required to scale TX power, and
an indication of which tower or sector identification (ID) to which a basic service set (BSS) applies.

3. The apparatus according to claim 1, wherein the processing circuitry is further configured to:
determine whether a reception quality satisfies a minimum threshold; and
transmit, in response to the reception quality not satisfying the minimum threshold, an indication of a low reception quality to the AP.

4. The apparatus according to claim 1, wherein the processing circuitry is further configured to:
provide a first probe request at a first power transmission level; and
provide a second a probe request at a second power transmission level, the second power transmission level being higher than the first power transmission level.

5. The apparatus according to claim 1, wherein the processing circuitry is further configured to transmit, to a serving AP, an indication of a received signal power.

6. The apparatus according to claim 1, wherein the processing circuitry is further configured to read a relative power reduction field in the CPSs and scale a transmission power according to a relative scaling value.

7. A user equipment, comprising:
the apparatus according to claim 1; and
a transceiver.

8. An apparatus for use in an access point (AP), the apparatus comprising:
processing circuitry configured to:
operate in a reduced coverage mode to reduce an overlap between a first coverage area of the AP and a second coverage area of another AP;
generate a beacon that includes a capability field and an information element, the capability field including an indication that the AP is operating in the reduced coverage mode, and the information element including a plurality of coverage sealing parameters (CSPs); and
transmit the beacon to one or more stations (STAs).

9. The apparatus according to claim 8, wherein the processing circuitry is further configured to:
calculate a power reduction for the reduced coverage mode, and
insert an indicator of the power reduction in the CSP.

10. The apparatus according to claim 8, wherein plurality of the CSP include:
a relative transmission (TX) power reduction,
an indication of whether a current frame is transmitted with a maximum or current power,
an indication of whether stations (STAs) are required to scale TX power, and
an indication of which tower or sector identification (ID) to which a basic service set (BSS) applies.

11. The apparatus according to claim 8, wherein the processing circuitry is further configured to:
determine a duration of a coverage scaling; and
provide an indication of the duration in the CSP.

12. The apparatus according to claim 11, wherein the processing circuitry is further configured to:
transmit one or more measurement probes to one or more other APs;
determine one or more downlink scaling values; and
transmit a request to at least one of the one or more other APs for coverage scaling.

13. The apparatus according to claim 8, wherein the processing circuitry is further configured to:
provide a probe request that requests a received power level; and
utilize a reply to the probe request to calculate the power reduction.

14. The apparatus according to claim 8, wherein
the reduced coverage mode is a specific basic service set (BSS) of one or more BSS or one of at least one direction, and
the processing circuitry is further configured to transmit an indication, to one or more affected STAs, of the reduced coverage mode while maintaining a previous coverage for non-affected STAs.

15. A method, comprising:
receiving, by an apparatus from an access point (AP), a beacon that includes a capability field and an information element, the capability field including an indication that the AP is operating in a reduced coverage mode, and the information element including a plurality of coverage sealing parameters (CSPs);
transmitting, in response to the apparatus operating in a passive scanning mode, uplink (UL) communication in accordance with the CSPs; and
transmitting, in response to the apparatus operating in an active scanning mode, a probe request in accordance with the CSPs, wherein
the reduced coverage mode of the AP reducing an overlap between a first coverage area of the AP and a second coverage area of another AP.

16. The method according to claim 15, wherein the plurality of CSPs include:
a relative transmission (TX) power reduction,
an indication of whether a current frame is transmitted with a maximum or current power,
an indication of whether stations (STAs) are required to scale TX power, and
an indication of which tower or sector identification (ID) to which a basic service set (BSS) applies.

17. The method according to claim 15, further comprising:
determining whether a reception quality satisfies a minimum threshold; and
transmitting, in response to the reception quality not satisfying the minimum threshold, an indication of a low reception quality to the AP.

18. The method according to claim 15, further comprising:
providing a first probe request at a first power transmission level; and
providing a second a probe request at a second power transmission level, the second power transmission level being higher than the first power transmission level.

19. The method according to claim 15, further comprising:
transmitting, to a serving AP, an indication of a received signal power.

20. The method according to claim 15, further comprising:
reading relative power reduction field in the CPSs; and
scaling a transmission power according to a relative scaling value.
